(19) United States
(12) Patent Application Publication
(10) Pub. No.: US 2002/0025016 A1
(43) Pub. Date: Feb. 28, 2002

(54) Accelerator-driven transmutation of spent fuel elements

(76) Inventors: Francesco Venneri, Los Alamos, NM (US); Mark A. Williamson, Naperville, IL (US); Ning Li, Los Alamos, NM (US)

Correspondence Address: Samuel M. Freund, Los Alamos National Laboratory, LC/BPL, MS D412, Los Alamos, NM, 87545, US

(21) Appl. No.: 09/834,980

(22) Filed: Apr. 13, 2001

Related U.S. Application Data
(63) Continuation-in-part of application No. 09/346,770, filed on Jul. 7, 1999, now abandoned.
Application No. 09/346,770 is a division of application No. 08/869,327, filed on Jun. 5, 1997, now abandoned.

(51) Int. Cl. G21G 1/10

(52) U.S. Cl. 376/195

(57) ABSTRACT

An apparatus and method is described for transmuting higher actinides, plutonium and selected fission products in a liquid-fuel subcritical assembly. Uranium may also be enriched, thereby providing new fuel for use in conventional nuclear power plants. An accelerator provides the additional neutrons required to perform the processes. The size of the accelerator needed to complete fuel cycle closure depends on the neutron efficiency of the supported reactors and on the neutron spectrum of the actinide transmutation apparatus. Treatment of spent fuel from light water reactors (LWRs) using uranium-based fuel will require the largest accelerator power, whereas neutron-efficient high temperature gas reactors (HTGRs) or CANDU reactors will require the smallest accelerator power, especially if thorium is introduced into the newly generated fuel according to the teachings of the present invention. Fast spectrum actinide transmutation apparatus (based on liquid-metal fuel) will take full advantage of the accelerator-produced source neutrons and provide maximum utilization of the actinide-generated fission neutrons. However, near-thermal transmutation apparatus will require lower standing inventories of plutonium and higher actinides. Uranium, presently the largest volume constituent in nuclear waste, is fully utilized and not discharged as waste. Since no plutonium, higher actinides or fission products are present in the reconstituted fuel elements, the present processes can be used repeatedly. Moreover, because the performance of the existing reactors is not changed, full utilization of both thorium and uranium resources is achieved.

### RELATED CASES

The present patent application is a continuation-in-part application of and claims the benefit of patent application Ser. No. 09/346,770 filed on Jul. 7, 1999 which is a divisional application of patent application Ser. No. 08/869,327 filed on Jun. 5, 1997.

### FIELD OF THE INVENTION

The present invention relates generally to processing of spent fuel rods and, more particularly, to accelerator-driven transmutation of spent fuel elements such that actinides and long-lived fission products are transmuted, and electrical power and new fuel are generated. This invention was made with government support under Contract No. W-7405-ENG-36 awarded to The Regents of the University of California by the U.S. Department of Energy. The government has certain rights in the invention.

### BACKGROUND OF THE INVENTION

Present nuclear waste strategies, centered about geologic repository storage, require geologic stability and separation of wastes from human contact for tens of thousands of years. Transmutation offers the potential for transforming the time scales associated with such storage to hundreds of years or less.

Transmutation of long-lived nuclear wastes to short-lived or stable isotopes has been studied for many years. A sampling of illustrative techniques is presented in “A Conceptual Study of Actinide Transmutation System With Proton Accelerator: (1) Target Neutronics Calculation,” by H. Takada et al., Proceedings Of The 2^{nd} International Symposium On Advanced Nuclear Energy Research-Evolution By Accelerators, Jan. 24-26, 1990 Mito, Ibaraki, Japan. Therein, the authors describe a transmutation apparatus using KeV neutrons which requires large material inventories to achieve significant transmutation rates since cross sections for neutron capture are small at these neutron energies. Moreover, the proton beam is admitted to the subcritical reactor target using a window, which limits the neutron flux available for the process. The direct interaction between the proton beam and the sodium coolant will produce substantial quantities of oxygen, carbon, nitrogen, and hydrogen spallation products which may combine to generate tar. Finally, degradation of the cladding material for the nuclear waste as a result of proton bombardment may present a lifetime problem. In “Accelerator Molten-Salt Breeding And Thorium Fuel Cycle, ” by Kazuo Furukawa et al., Proceedings Of The 2^{nd} International Symposium On Advanced Nuclear Energy Research-Evolution By Accelerators, Jan. 24-26, 1990, Mito, Ibaraki, Japan, the authors describe a windowless apparatus accepting high proton beam currents having GeV energies which are caused to impinge directly on the target materials as in Takada et al., supra, except cooled by molten salt. Transmutation is achieved using keV neutrons where the low cross sections of the neutrons require large inventories to achieve useful transmutation throughput. Additionally, since the thorium is mixed with lithium fluoride, proton spallation will again produce bothersome tars.

In “Status Report Of The SIN Neutron Source,” by G. Atchison and W. E.

Fisher, Proceedings Of International Collaboration On Advanced Neutron Sources (ICANS-VII), Sep. 13-16, 1983, Atomic Energy Of Canada, Limited, Report AECL-8488, the authors disclose a low-power target for low flux neutron production in Pb—Bi from neutron bombardment with subsequent neutron thermalization using heavy water. Heat is removed from the target by thermal convection, and the low power levels also permit the use of a window between the accelerator vacuum and the target. The proton beam strikes the target from below which has advantages for thermal convection cooling.

In “Apparatus For Nuclear Transmutation And Power Production Using An Intense Accelerator-Generated Thermal Neutron Flux,” by Charles D. Bowman, U.S. Pat. No. 5,160,696, which issued on Nov. 3, 1992, the teachings of which are hereby incorporated by reference herein, high thermal neutron fluxes generated from the action of a high power proton accelerator on a spallation target allows the efficient burn-up of higher actinide nuclear waste by a two-step process. Additionally, rapid burn-up of fission product waste for nuclides having small thermal neutron cross sections, and the practicality of small material inventories while achieving significant throughput derive from employment of such high fluxes. The apparatus includes an accelerator, a target for neutron production surrounded by a blanket region for transmutation, a turbine for electric power production, and a chemical processing facility.

Accordingly, it is an object of the present invention to efficiently and subcritically transmute plutonium, higher actinides and long-lived fission products in nuclear waste streams while producing newly-enriched uranium for fuel reconstitution for use in base-load, conventional nuclear reactors.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, the method for processing spent fuel from nuclear reactors hereof includes the steps of: converting the spent fuel to elemental metals; electrorefining uranium and thorium onto an electrode, thereby removing uranium and thorium from the elemental metals; electrorefining transuranic elements into a molten bismuth cathode, thereby removing transuranic elements from the elemental metals, homogeneously mixing the transuranic elements dissolved in molten bismuth with molten lead, or placing the transuranic elements dissolved in molten bismuth in canisters; exposing the bismuth/lead solution to an intense flux of fast protons or the canisters to an intense flux of fast neutrons, respectively; and separating the transmutation products for storage thereof, whereby plutonium and higher actinides, and fission products are transmuted.

Three ATW-NCC (Accelerator Transmutation of Wastes-Nuclear Cycle Closure) options are described, one of which will be pursued depending on whether nuclear power is to be eventually phased out (ATW-NCC1), continued at the present level or moderately increased levels (ATW-NCC2), or substantially expanded (ATW-NCC3). Functionally, these options are approximately equivalent to the options of once-through cycling, multiple reprocessing and full-fledged breeding, respectively, envisioned for nuclear power systems using current technology.

The three ATW-NCC options utilize spent fuel generated by any existing and conceivable future types of nuclear reactors. ATW-NCC's front-end processes produce a feed of unseparated actinides suitable for nearly complete subcritical burning in the actinide burn unit which is driven by a large-current linear accelerator (LINAC). Power production to offset operational costs is optional.

In ATW-NCC1, excess neutrons generated by the accelerator and the fission of the higher actinides are used in a blanket/reflector containing long-lived fission products to be transmuted. The separated uranium is collected and sent to permanent storage. ATW-NCC1 requires the smallest LINAC driver.

Plutonium and higher actinides are completely eliminated. The long-lived fission products technetium-99 and iodine-129 are transmuted, while cesium-135, cesium-137 and strontium-90 will not be transmuted in the ATW system. Uranium is not processed.

In ATW-NCC2 and 3, because of the deep subcriticality, a large number of neutrons is available to breed new ²³³U in a surrounding thorium blanket. This ²³³U is used to enrich uranium previously extracted from the spent fuel, and new fuel can be fabricated for use in base-load (power) reactors. ATW-NCC2 supported reactors will use uranium fuel. Reactors supported by ATW-NCC3 systems will use denatured thorium fuel, allowing a better fuel utilization factor at the expense of more complex process chemistry. Plutonium and higher actinides are removed from circulation after being generated in the base-load reactors: they are destroyed in their first (and only) pass through the ATW Actinide Burn apparatus and never recycled. About ⅓ of the uranium and thorium energy content is utilized in ATW-NCC2 (to use it completely would require a three-times larger accelerator or a smaller number of supported base-load reactors). The introduction of thorium in the base-load reactor fuel (ATW-NCC3) will eventually allow full utilization of the uranium and thorium energy resources with minimum accelerator size and a maximum number of supported base-load reactors. Both thermal (based on molten salt fuel) and fast-spectrum (based on liquid lead-bismuth fuel) are possible for the ATW Actinide Burn apparatus, with a significant neutronic advantage being gained for the ATW-NCC2 and -NCC3 systems by the adoption of the very hard spectrum liquid metal ATW burner.

Benefits and advantages of the present invention include the elimination of plutonium, higher actinides and selected fission products from the nuclear waste stream. With the implementation of ATW-NCC2 and -NCC3-type systems, efficient (and eventually full) utilization of the existing uranium and thorium energy resources will become possible. Additional advantages include the acceptance of nuclear spent fuel from any existing type of nuclear reactor, the prevention of plutonium accumulation, proliferation and diversion at all levels, full compatibility within the existing nuclear infrastructure of base-load reactors, and reduction of the volume of nuclear waste to be permanently stored (including uranium, and thorium in the ATW-NCC2 and -NCC3 concepts) by a factor of greater than 100.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a schematic representation of the top view of the cross section of the actinide and fission product transmutation apparatus for the molten salt embodiment of the present invention.

FIG. 2 is a schematic representation of the relationship among the process steps for the preparation of feed material and transmutation thereof, storage of the resulting materials, and preparation of new reactor fuel in accordance with the method of the present invention for the molten salt/continued use of nuclear power generation embodiment thereof.

FIG. 3 is an expanded schematic illustration of the fuel preparation step shown in FIG. 2 hereof.

FIG. 4 is a schematic representation of steps for separation of the product materials resulting from transmutation of fission products according to the teachings of the present invention as illustrated in FIG. 2 hereof prior to storage.

FIG. 5 is a schematic representation of the top view of the cross section of the actinide and fission product transmutation apparatus for the liquid metal embodiment of the present invention.

FIG. 6 is a schematic representation of the relationship among the process steps for the preparation of feed material and transmutation thereof, storage of the resulting materials, and preparation of new reactor fuel in accordance with the method of the present invention for the liquid metal/continued use of nuclear power generation embodiment thereof.

FIG. 7 is an expanded schematic illustration of the fuel preparation step shown in FIG. 6 hereof.

FIG. 8 is a schematic representation of steps for separation of the product materials resulting from transmutation of fission products according to the teachings of the present invention as illustrated in FIG. 6 hereof prior to storage.

### DETAILED DESCRIPTION

Briefly, ATW-NCC according to the teachings of the present invention includes fuel preparation; actinide transmutation (via the actinide burn apparatus); uranium enrichment (via a blanket of thorium); and fuel reconstitution (the last two parts applying only to ATW-NCC2 and ATW-NCC3):

I. Fuel Preparation:

Spent fuel derived from operating nuclear reactors (LWRS, HTGRs, CANDU, and others) is processed using hydrofluorination and electrowinning for the molten salt-based system, and oxide reduction and electrorefining for the lead-based system. The process allows the separation of the enriched uranium and/or thorium contained in the spent fuel without plutonium extraction.

II. Plutonium, Higher-actinide and Selected Fission-product Transmutation:

Subsequent to fuel preparation, destruction of plutonium, higher actinides and selected fission products is accomplished using a subcritical transmutation apparatus with an effective reactivity of between 0.95 and 0.98. Two configurations are possible: a graphite-reflected molten salt system, and a fast neutron system based on liquid lead. This fast spectrum configuration does not attempt to moderate neutrons and supplies neutrons for utilization in a uranium enrichment blanket, at the expense of a larger inventory of plutonium and higher actinides in the burn apparatus. Neutrons for sustaining the transmutation process are generated in a liquid metal spallation target driven by a large-current (>10 mA) proton accelerator which generates protons in the 1 GeV energy range. No separate target is envisioned for this embodiment. Spallation neutrons produced have energies between 0 and 200 MeV. The high-flux (≧5×10¹⁵ n/cm²·s) transmutation is assisted by the cleanup processes for fission product removal which includes sparging, electrowinning and reductive extraction. The transmutation proceeds to near completion, and only certain fission products are discharged by the process.

It should be mentioned that a reactivity of 0.95 is equivalent to dry storage of nuclear materials without control and is considered to be safe. At this deep subcriticality (a critical reactor's reactivity is 1), a transmutation system can not sustain reaction when the accelerator shuts down. The accelerator's current, or driving capacity, is limited by the design and cannot exceed the maximum. A transmutation system also uses non-fertile fuels that guarantee decreasing reactivity since neutrons are absorbed.

III. Uranium Enrichment:

In ATW-NCC2 and 3, the actinide transmutation occurs in a deep-subcritical mode (k_{eff}<<1, where k_{eff} is the reactivity of the system and will be discussed more fully hereinbelow), with a large fraction of neutrons leaking out of the apparatus into a near-zero-power thorium fluoride blanket designed to enrich uranium. The thorium blanket includes molten thorium fluoride in a suitable carrier salt (LiF, BeF₂); NaF can be substituted for LiF if tritium production in this unit is a problem. Depending on the current of the accelerator beam, as many as three neutrons per fission occurring in the actinide transmutation apparatus escape from the apparatus and are absorbed in the thorium blanket. U-233 isotope is produced by neutron capture in the thorium blanket. Extracted U-233 can be used to enrich the low-enrichment uranium separated from the spent fuel in the fuel preparation process to a desired enrichment. A fission product transmutation loop completes the design of the blanket. The extraction process leaves the thorium in the enrichment blanket. Protactinium-233 is produced by neutron absorption in thorium-232 within the breeding blanket. It subsequently decays, with a 27-day half-life, to uranium-233. Extraction of uranium from the breeding salt will also extract any protactinium that has not yet decayed to uranium-233. The extraction process does not affect the thorium. An alternative to extracting the protactinium with the uranium is to place the molten salt in a hold-up tank for 270 days (10 times the protactinium-233 half-life), which provides adequate time for protactinium decay. Experimental studies by Ferris et al. (L. M. Ferris et al. in “Equilibrium Distribution Of Actinide And Lanthanide Elements Between Molten Fluoride Salts And Liquid Bismuth Solutions”, J. Inorg. Nucl. Chem. 32, 2019 (1970 and L. M. Ferris et al. in “Chemistry And Thermodynamics Of The Distribution Of Lanthanide And Actinide Elements Between Molten LiF-BeF₂ and Liquid Bismuth Solutions”, J. lnorg. Nucl. Chem. 33, 1325 (1971)) have shown that protactinium and uranium behave similarly in the extraction process and are more easily removed (by a factor greater than 1000) from the breeding salt than is thorium. IV. Fuel reconstitution:

In the ATW-NCC2 and 3 processes, the uranium-23 from the thorium blanket in part III above is converted to its oxide form and homogeneously mixed with the bulk of the uranium extracted from the spent fuel in part I above in its oxide form. The resulting uranium (now enriched with a blend of 233 and 235 isotopes up to 4%) is reacted to its oxide form and shipped to the fuel fabrication plant, or processed on-site into metal or oxide fuel elements. Thorium can be similarly reintroduced into the fuel cycle (ATW-NCC3). The newly fabricated fuel elements, produced according to customary fabrication techniques, can be used for refueling the base-load reactors.

Although the ATW-NCC2 fuel cycle is the subject of the present invention, in what follows the neutronic performance of the three ATW-NCC systems will be described:

A. ATW-NCC1 transmutes plutonium and higher actinides coming from spent fuel without recycling or reconstituting the fuel. A typical 3000 MW reactor consumes 1200 kg/yr of fissile material and discharges 300 kg/yr of plutonium and higher actinides suitable for transmutation in the apparatus of the present invention. Therefore, a transmutation reactor which services four reactors by destroying spent fuel plutonium and higher actinides will produce 3000 MW, the same as one of the reactors being serviced. The surplus neutrons generated in the transmutation (by actinide fissions and by the accelerator-driven source) are available to transmute long-lived fission products.

B. In addition to long-lived fission product transmutation, ATW-NCC2 systems permit reconstitution of the fuel (re-enrichment) for further use in the supported reactors using uranium fuel. These reactors will also discharge 300 kg/yr of plutonium and higher actinides which will have to be transmuted. Additional work is required from the neutrons generated in the transmutation apparatus, as they now have to enrich uranium so to makeup the fissile inventory lost during power generation by the reactors. Uranium-based thermal reactors are well known to have inefficient neutron economy, especially the Light Water Reactors (LWRs), for which about 600 kg/yr of fissile inventory per supported reactor will have to be produced in order for the fuel to be reconstituted to original specifications. Since 300 kg/yr of plutonium and higher actinides are discharged per reactor and destroyed in transmutation apparatus and 600 kg/yr of new fissile material has to be produced in the enrichment blanket per supported reactor, at least 2 neutrons per fission have to be made available in the transmutation apparatus for use in the enrichment blanket, where they will be absorbed in the thorium to produce fissile ²³³U.

C. ATW-NCC3 systems will reconstitute the fuel for use in the supported reactors, producing denatured thorium fuel. The denatured thorium fuel is made of about 80% thorium and 20% uranium, enough to denature the ²³³U produced during the cycle with sufficient amounts of ²³⁸U so to render the resulting uranium unusable for weapons construction. Much less plutonium and higher actinides are generated in the base-load reactors using the denatured thorium option than using uranium-based fuel. The plutonium produced will then be diluted, nonweapons grade ²³⁸Pu. A typical 3000 MW reactor burning denatured thorium fuel will produce only 100 kg/yr of plutonium and higher actinides for destruction in ATW-NCC3 systems. The denatured thorium cycle also has a more favorable neutron economy, and only 200 kg/yr of fissile material per supported reactor will have to be produced in ATW-NCC3 systems. Since 100 kg/yr of plutonium and higher actinides are discharged per reactor and destroyed in the transmutation apparatus and 200 kg/yr of new fissile material has to be produced in the enrichment blanket per supported reactor, at least 2 neutrons per fission have to be made available to the enrichment blanket, where they will transmute thorium to fissile ²³³U.

Thus, for the same thermal power generated in the accelerator-driven actinide transmutation apparatus, three times as many base-load reactors (operating on denatured thorium fuel) can be supported by ATW-NCC3 systems as opposed to ATW-NCC2 systems where the same reactors are operated on uranium-based fuel.

The following is a description of the basic neutronics for subcritical systems:

In ATW-NCC systems, neutrons are used in three ways: destruction of plutonium and higher actinides, transmutation of fission products, and fuel re-enrichment. Neutrons are generated by spallation in the accelerator-driven source and by fission of the fissile species (plutonium and higher actinides). The following basic equation relates source and fission generated neutrons, and governs the behavior of subcritical systems:

k_{eff}=n/{1+A+P+L},

where k_{eff}, the reactivity of the system, is related to the system neutron multiplication, M, by the equation:

M=1/{1−k_{eff}},

where

n is the average number of neutrons released by each fission, P is the number of neutrons parasitically absorbed in the system per fission, L is the number of neutrons leaving the system (leakage) per fission, and A is the ratio of neutron absorption to fission cross section in the active component of the fuel (plutonium and actinides in the case of the present transmutation apparatus). Critical (self-driven) systems have k_{eff}=1 and infinite multiplication.

If the transmutation apparatus is operated with a fast neutron spectrum (lead-based system, k_{eff}=0.75), the values for the parameters are: A=0.6; P=0.2; n>3, whereas if the apparatus is operated with a more thermal spectrum (molten salt reflected by graphite, k_{eff}=0.60), then the values for the parameters are: A=1.4; P=0.4; n<3. Values of n substantially larger than 3 may be possible in fast, deeply subcritical systems, where a substantial number of fissions are initiated by high energy spallation neutrons instead of relatively slow fission neutrons.

Introducing these values to the governing equation, it becomes apparent that more neutrons are available for use (assumed as 80% of leakage neutrons ) in the fast-spectrum system than in the more thermal system (for the same value of k_{eff}) or, alternately, that higher k_{eff} fast-spectrum systems will generate the same number of usable neutrons as lower k_{eff}, slower-spectrum systems with lower multiplication, therefore requiring larger accelerators. On the other hand, inventories in fast-spectrum systems tend to be appreciably larger than those for slower-spectrum systems.

Some of the fission products targeted for transmutation remain in the fuel of the transmutation apparatus and their transmutation is accounted for in the fuel capture parameter P. Some fission products will have to be transmuted outside the burner in additional loops by leakage neutrons. For ATW-NCC1 systems, 0.2 neutrons per fission are needed to affect the transmutation of these long-lived fission products. In a near-thermal spectrum configuration (molten salt reflected by graphite), a subcritical system (driven by the accelerator) operating at k_{eff}=0.95 will free additional neutrons to allow 0.2 leakage neutrons per fission to be used for fission product transmutation. The concept and feasibility of subcritical accelerator-driven systems has been established by Bowman, supra, and by subsequent research.

In the case of ATW-NCC2, 2.2 neutrons per fission are required to produce the desired transmutations and to re-enrich the uranium fuel for further use in the base-load reactors. Because of the larger number of reactors which can be supported, ATW-NCC3 units require 2.6 neutrons per fission to perform the same function. If no transmutation of the long-lived fission products is desired, both systems will require two usable leakage neutrons per fission.

Fast-spectrum systems (the lead-based configuration) can contribute at least one usable neutron from internal fissions to the blanket, the remainder must be provided by an accelerator-driven source. For slower-spectrum systems (the molten-salt based configuration), essentially all the usable leakage neutrons are derived from the accelerator-driven source. Therefore, the source strength (accelerator size) will be considerably larger in the ATW-NCC2 and ATW-NCC3 systems based on slower-spectrum configurations.

The following describes the process chemistry of the ATW-NCC system:

A. Molten Salt System:

Reference will now be made in detail to the present preferred embodiments of the invention, examples of which are illustrated in the accompanying drawings. Identical callouts are used to describe similar or identical structure or process steps.

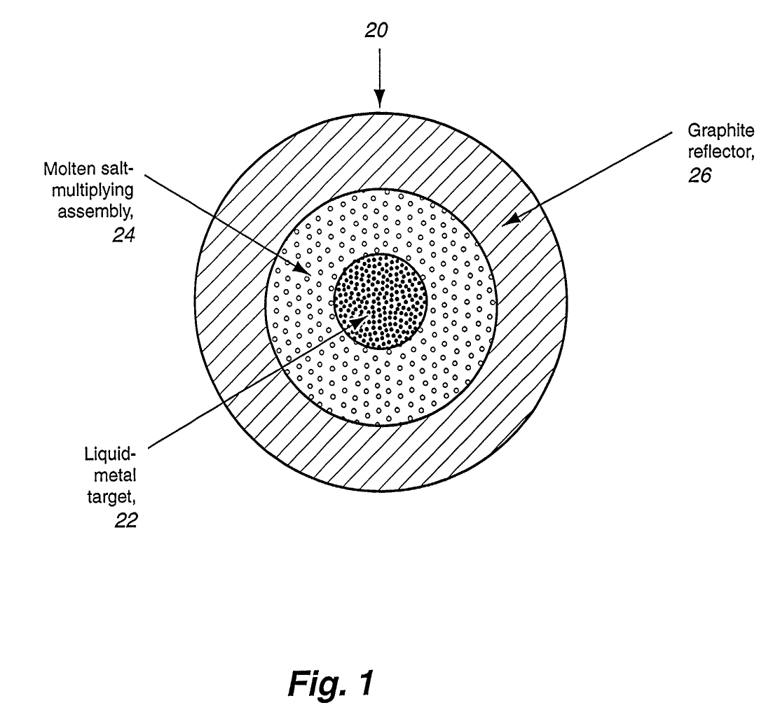

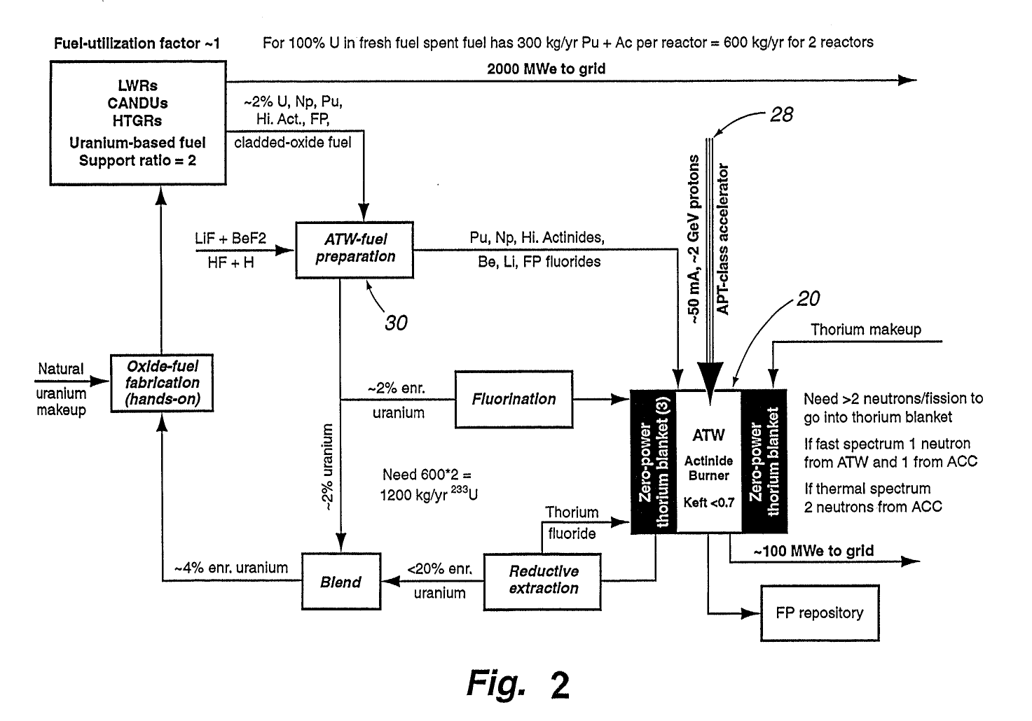

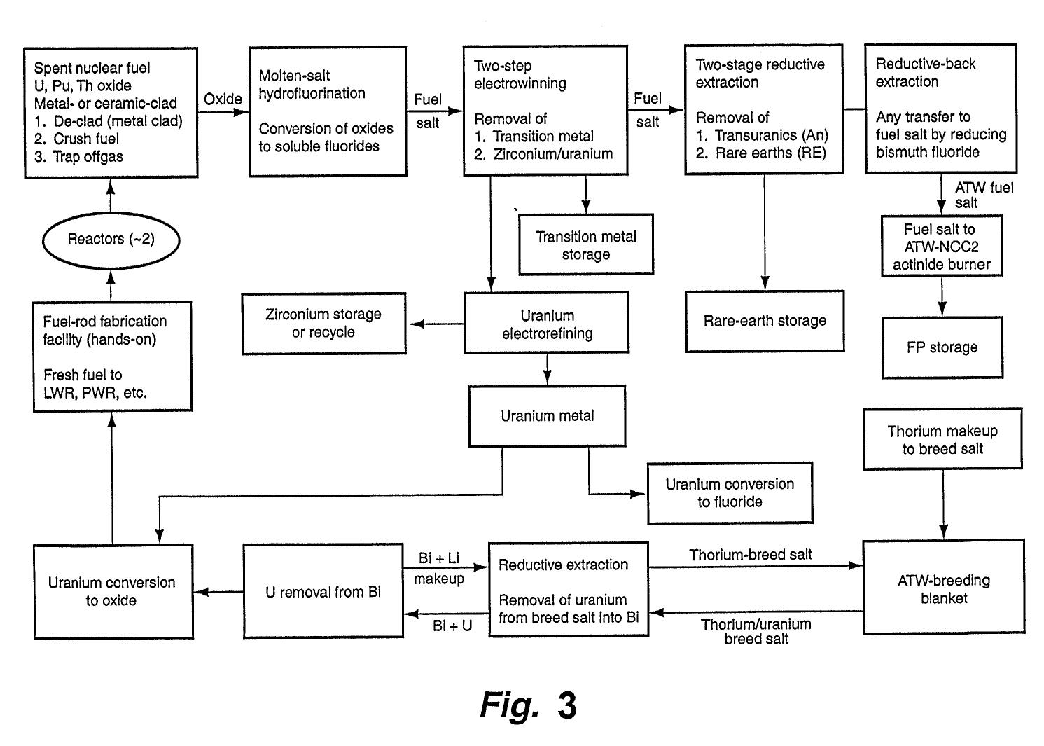

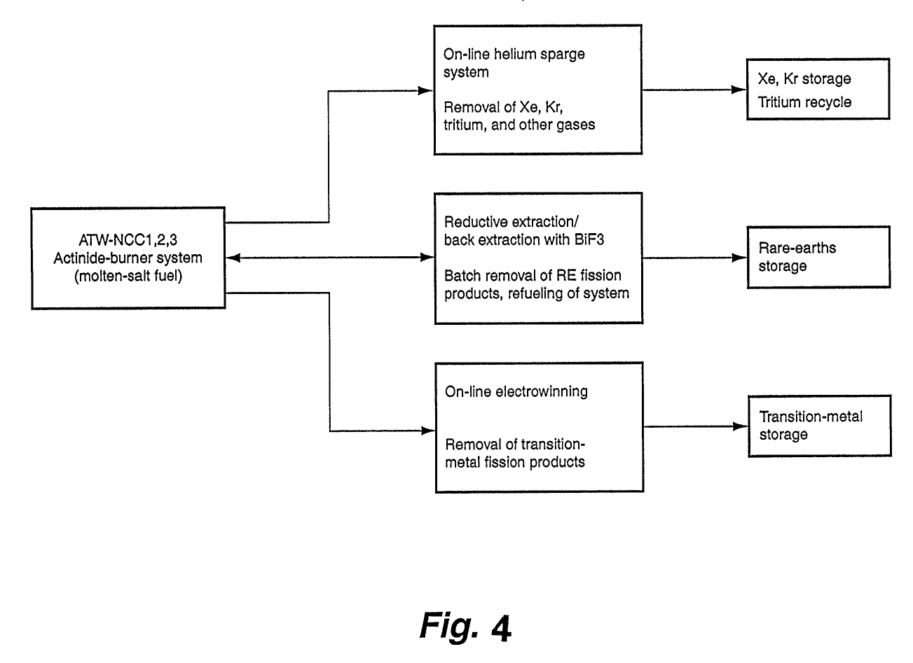

FIG. 1 is a schematic representation of the top view of the cross section of the actinide and fission product transmutation apparatus, 20, for the molten salt, thermal neutron spectrum embodiment of the present invention. A liquid metal target, for example, lead or lead/bismuth, 22, is surround by a molten salt multiplying assembly, 24, and a graphite reflector, 26. Liquid metal target 20 is exposed to a high current density of protons, 28. FIG. 2 is a schematic representation of the steps for accomplishing the goals of the ATW-NCC2 molten salt, thermal neutron spectrum option of the present invention, where actinides are destroyed and uranium fuel is recycled, while FIG. 3 is an expanded schematic representation of the fuel preparation step, 30, of FIG. 2. FIG. 4 is a schematic representation of the fission product removal steps from the molten salt located in the actinide burner portion, 24, of the actinide and fission product transmutation apparatus, 20, for the ATW-NCC2 thermal neutron spectrum option.

Having generally described the molten salt embodiment of the present invention, the following expands upon some of the principal processing steps. The three principal chemical processes associated with the ATW-NCC molten-salt fuel cycle are: molten salt hydrofluorination, electrowinning and reductive extraction.

1. Molten Salt Hydrofluorination:

Spent nuclear fuel consists of plutonium oxide, uranium oxide, fission product oxides, gaseous fission products trapped in the oxide matrix, and likely Zircalloy cladding material. Some fission products, uranium, and zirconium are undesirable constituents of the feed for the ATW-NCC where no further production of plutonium from ²³⁸U is desired. The preparation of transmuted fuel from spent nuclear fuel is accomplished as follows. After the fuel has had sufficient time to cool, the fuel pins are chopped by conventional means. Alternatively, the fuel might be decladded and only the oxide fuel chopped. The fission product gas released during the chopping is adsorbed on activated charcoal or molecular sieves. The chopped fuel is fed into a nickel or nickel-alloy chemical reactor that contains 0.67 LiF/0.33 BeF₂ molten salt at 1000 K.

Next, the chopped fuel is hydrofluorinated in the presence of excess hydrogen by bubbling HF into the molten salt at 1000 K. Excess hydrogen is required to prevent the formation of high oxidation state metal fluoride species, for example UF₄, PuF₄, MoF₆. The equations that describe these processes are:

MOₙ/2(c)+n HF(g)=MFₙ(d)+n/2 H₂O(g), (1)

MO_{n/}₂(c)+(n−1)HF(g)+½H₂(g)=MFₙ₋₁(d)+n/2 H₂O(g), and (2)

M(c)+n HF(g)=MFₙ(d)+n/2 H₂(g), (3)

where MO_{n/2} is a metal oxide of metal valence n, M is cladding metal, and MFₙ or MFₙ₋₁ (d) is the metal fluoride dissolved in the LiF/BeF₂. The reactions are spontaneous; for example, the free energy change for the conversion of plutonium dioxide to plutonium trifluoride with HF is 125 kJ/mol. The resulting fluoride mixture is then transferred to the electrochemical cell.

2. Electrowinning:

Electrochemical processes are used to separate the metals and the uranium dissolved as fluorides in the molten salt (See e.g., U.S. Pat. No. 4,995,948 for “Apparatus And Process For The Electrolytic Reduction Of Uranium And Plutonium Oxides” which issued to David S. Poa et al. on Feb. 26, 1991). The electrochemical cell consists of a consumable anode, either zirconium or beryllium, and a nickel cathode onto which the metals are deposited.

The electrowinning process is completed in two steps. First, a zirconium anode is used to deposit transition metals on the cathode and in the second step, a beryllium anode is used to deposit uranium and zirconium on the cathode. The equations that describe these processes are:

nZr(s)+4MFₙ(d)=nZrF₄(d)+4M(s), and (4)

nBe(s)+2MFₙ(d)nBeF₂(d)+2M(s), (5)

where MFₙ(d) is a metal fluoride dissolved in molten LiF/BeF₂. The reactions are spontaneous because of the free energy difference between metal fluorides. For example, consider the removal of 5 mol % of uranium present as uranium tetrafluoride from a 0.28 BeF₂/0.67 LiF/0.05 UF₄ molten salt. The free energy change for Reaction (5) is −109 kJ/mol. Therefore, in principle, the cell could be operated in a passive fashion (i.e., no external voltage source required). However, the efficiency of the cell is enhanced by applying an externally generated voltage. Thorium, plutonium, higher actinides, lanthanides, strontium, cesium and iodine remain in the molten salt.

One of the features of the LiF/BeF₂ molten salt is automatic plutonium proliferation resistance. Plutonium cannot be isolated from this system because of the electromotive force (emf) for beryllium; that is, the oxidation potential of beryllium falls below the plutonium emf. Therefore, all of the beryllium must be removed from the system before any of the plutonium can be isolated by electrochemical methods.

3. Reductive Extraction:

The process for separating the transuranic elements from the rare earth elements is a liquid-metal extraction process (See e.g., U.S. Pat. No. 5,141,723 for “Uranium Chloride Extraction Of Transuranium Elements From LWR Fuel” which issued to William E. Miller et al. on Aug. 25, 1992). The process includes contacting the molten salt, which contains the rare earths and transuranics, with a liquid bismuth stream containing a small quantity of lithium (0.1-1 atom % Li). The equation that describes this process is

nLi(I, in Bi)+MFₙ(d)=M(I, in Bi)+nLiF(d), (6)

where MFₙ is a transuranic or rare earth fluoride of valence n dissolved in the molten salt and M is the metal dissolved in bismuth. The process works equally well for the separation of uranium from the LiF/BeF₂/ThF₄ molten salt in the breeding blanket.

As an example, consider the separation of the transuranic and rare-earth elements. This process is proposed for producing a feed stream free of thorium fluoride for the actinide transmutation apparatus, and also for cleansing the transmutation apparatus fuel salt of the lanthanide fission products. The proposed process is a two-stage reduction process in liquid metal followed by a back extraction into the fluoride salt. In the first step, the lithium concentration (0.10 atom % Li) in the bismuth is selected so that the transuranics are preferentially extracted from the molten salt into the liquid bismuth phase where they remain in solution. The transuranics are preferentially extracted from the molten salt into the bismuth because they form thermodynamically less stable fluorides than the rare earths, the difference between free energies of formation of the species being approximately 170 kJ/mol. A different lithium concentration (1.0 atom % Li) is selected for use in the second step, so that the rare earths are removed from the salt and transferred into a second bismuth phase where they remain in solution.

After rare-earth removal, the transuranics are extracted from the liquid bismuth into the salt by contacting the bismuth stream from the first reduction step with a molten salt stream (LiF/BeF₂) which includes BiF₃. Bismuth fluoride has adequate solubility in the molten salt, but is thermodynamically less stable than the transuranic trifluorides and will oxidize the transuranics in the Bi stream and transfer them to the salt stream. The rare earths left in the second bismuth stream can be removed by decreasing the temperature of the bismuth and collecting the solids that are formed, oxidizing and blending the solids with silica, and stabilizing the waste material in an appropriate matrix. The bismuth from each stream would be recycled.

B. Liquid Metal System:

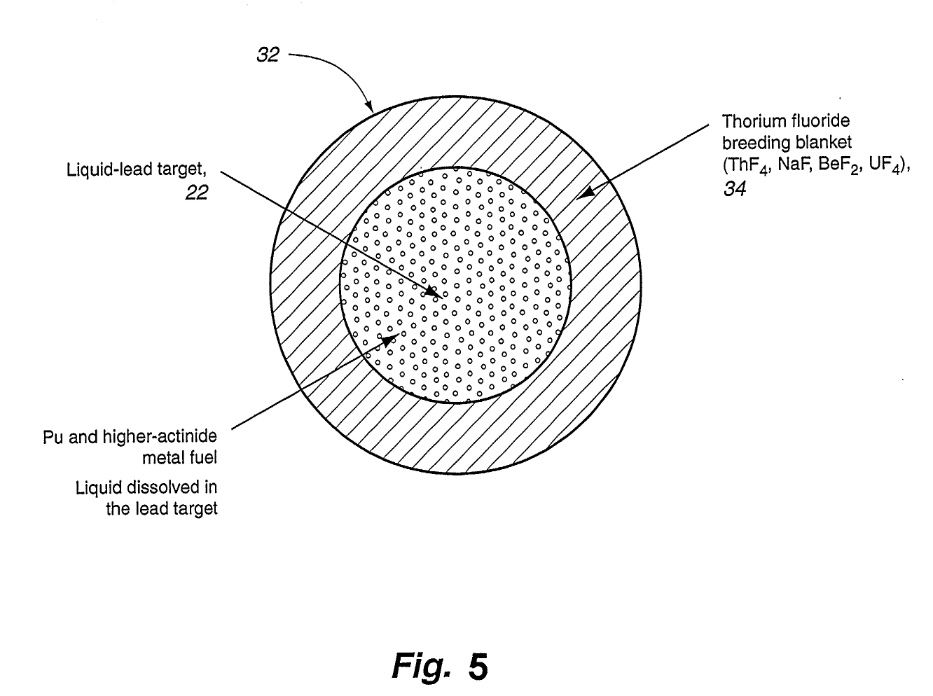

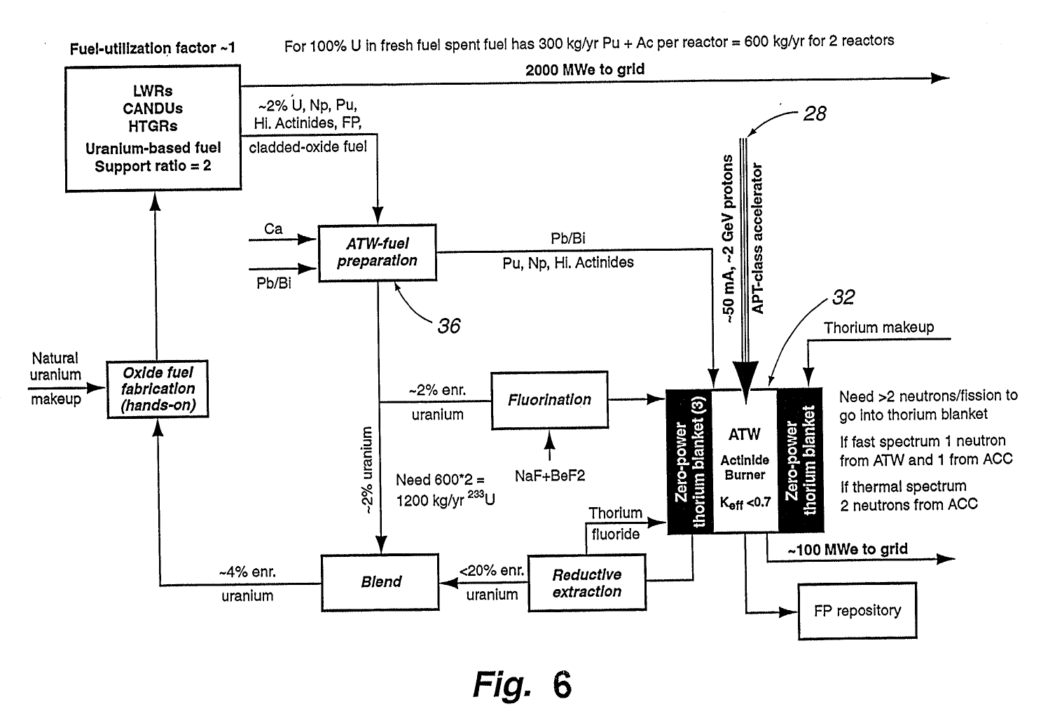

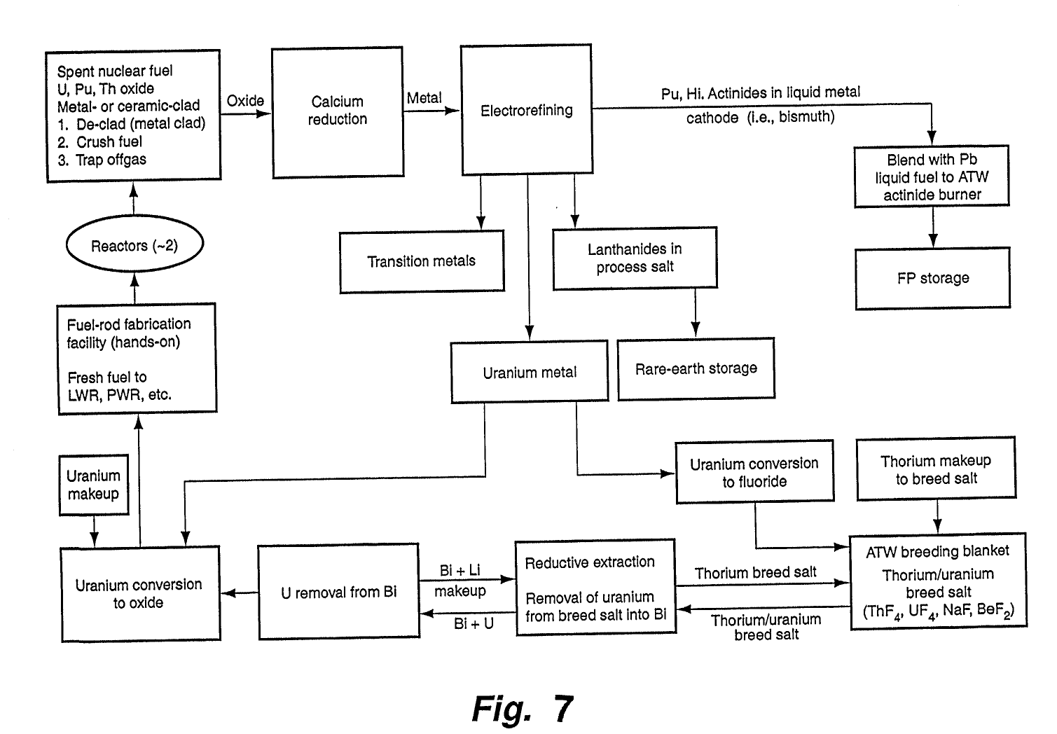

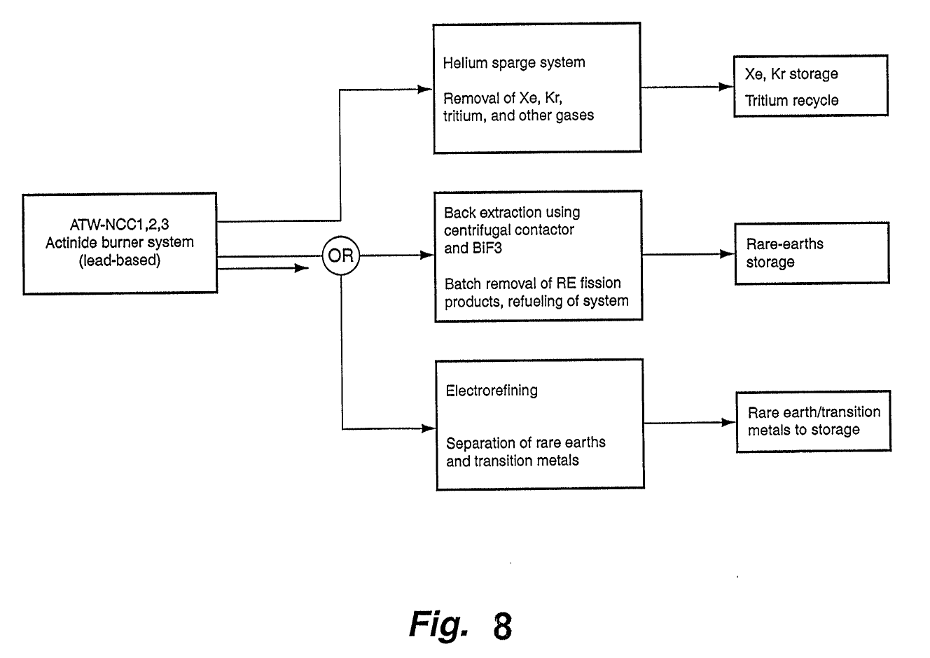

FIG. 5 is a schematic representation of the top view of the cross section of the actinide and fission product transmutation apparatus, 32, for the liquid metal, fast neutron spectrum embodiment of the present invention. A liquid metal target, for example, lead or lead/bismuth, 22, is surrounded by a molten thorium fluoride breeding blanket, 34, containing ThF₄, NaF, BeF₂, and UF₄. Unlike FIG. 1, a graphite reflector might not be required. Plutonium and higher actinide metal fuels are dissolved in the liquid metal target which is exposed to a high current density of protons. FIG. 6 is a schematic representation of the steps for accomplishing the goals of the ATW-NCC2 liquid metal, fast neutron spectrum option of the present invention, where actinides are destroyed and uranium fuel is recycled, while FIG. 7 is an expanded schematic representation of the fuel preparation step, 36, of FIG. 6. FIG. 8 is a schematic representation of the fission product removal steps from the liquid metal located in the actinide burner portion, 24, of the actinide and fission product transmutation apparatus, 32, for the ATW-NCC2, fast neutron spectrum option.

Having generally described the molten metal embodiment of the present invention, the following expands upon some of the principal processing steps. The three principal chemical processes associated with the ATW-NCC liquid lead fuel cycle are oxide reduction, electrorefining, and reductive extraction.

1. Oxide Reduction:

Spent nuclear fuel is converted to fuel for the liquid-metal fueled system by a two-step process (See e.g., U.S. Pat. No. 5,356,605 for “Recovery Of UO₂/PuO₂ In IFR Electrorefining Process” which issued to Zygmunt Tomczuk and William E. Miller on Oct. 18, 1994 and U.S. Pat. No. 5,141,723, supra). After the spent fuel is decladded and crushed, the oxide powder is mixed into a CaCl₂ molten salt which contains calcium metal. The calcium metal reduces the spent fuel metal oxides and produces metals (U, Pu, etc.). The calcium oxide that is produced is soluble in the calcium chloride. Calcium oxide dissolved in the calcium chloride can be converted to calcium chloride and the salt reused. The metals produced by the reduction process are then introduced to an electrorefining cell.

2. Electrorefining:

The metals produced by the calcium reduction process serve as the anode in the electrorefining cell (See e.g., U.S. Pat. No. 4,880,506 for “Electrorefining Process And Apparatus For Recovery Of Uranium And A Mixture Of Uranium And Plutonium From Spent Fuels” which issued to John P. Ackerman and William E. Miller on Nov. 14, 1989). The fluid within the cell is a NaCl/KCl molten salt with a small concentration of a weak metal chloride, such as bismuth chloride which functions in the same manner as cadmium chloride in U.S. Pat. No. 4,880,506, supra, and will oxidize a small quantity of the active metals. Two types of cathode materials are required. The first cathode is a bare metal rod or wire mesh attached to the rod and serves as a location for the thorium and uranium to deposit. The second cathode is liquid bismuth metal that will collect the transuranic elements as alloys. The deposition is controlled by an external power supply. The rare-earth elements remain in the molten salt and can be discarded. The transition metal elements remain at the anode and can be discarded. The bismuth-actinide alloys are blended with the liquid lead coolant/fuel carrier and directed to the transmutation apparatus. The uranium and thorium are recycled. The quantity of weak metal chloride (i.e., bismuth chloride) that must be added to the cell is determined by the concentration of active fission products, such as cesium, strontium, and rare earths, contained in the spent fuel. Sufficient weak metal chloride must be added to the system to oxidize the active fission products and also yield 4-8 mol % plutonium chloride in the NaCl-KCl salt. The plutonium chloride is needed to provide a transport pathway for moving plutonium from the anode to the cathode of the electrorefiner. The weak metal chloride is mixed with the NaCl/KCl as a solid or generated in-situ by sparging chlorine gas into the metal/molten salt system.

An effective electrorefiner would be similar to that studied by L. J. Mullins and J. A. Leary in “Fused-Salt Electrorefining Of Molten Plutonium And Its Alloys By The LAMEX Process”, Ind. Eng. Chem. Process Des. and Develop. 4, 394 (1965) for the molten salt electrorefining of plutonium and its alloys. The electrorefiner system employed included a liquid anode as is shown in FIG. 1 thereof. The molten salt electrolyte and the liquid anode are stirred to limit concentration gradients within the salt and anode. However, the rate of stirring is not great enough to form a mixture. The electrorefiner cell was operated at 840° C. so that the plutonium metal generated at the cathode drips off into a product collector. Typical operating parameters are described in the reference. Adaptation of this design to facilitate two cathodes; one for solid uranium and/or thorium deposition and one for transuranic deposition in a liquid metal, is straightforward. The liquid-metal cathode requires an electrical connection similar to that shown for the liquid anode by Mullins and Leary. A suitable cathode is a concentric ring around the anode which is similar to the product collection area in Mullins and Leary. The second cathode (a steel rod or wire mesh attached to the steel rod) is placed in the molten salt above the liquid cathode to collect the uranium and/or thorium. Electrotransport of the species from the anode of the system to the cathode is facilitated by an external power source.

3. Reductive Extraction:

Reductive extraction similar to the back extractiori process employed in the molten salt system will be used to remove the rare-earths, strontium, and cesium fission products from the liquid-lead carrier (See, e.g., U.S. Pat. No. 5,141,723, supra). The equation that describes the process is

3M(I, in Pb—Bi)+nBiCl₃(d)=nBiCl (I, in Pb—Bi)+3MClₙ(d), (7)

where MClₙ is a rare earth, strontium or cesium chloride of valence n dissolved in the NaCl/KCl molten salt and M is the metal dissolved in liquid metal carrier. The process is driven by the free energy difference between the metal chloride and the liquid metal alloys. The rare-earth strontium and cesium chlorides are more thermodynamically stable than the actinide chlorides and are preferentially extracted from the liquid metal fuel into the molten salt. The degree of separation is governed by the concentration of bismuth chloride in the molten salt. The rare-earth fission products collected in the molten salt are oxidized and blended with silica and sent to a storage facility.

Typical operating temperatures for the operations described hereinabove are set forth in the TABLE.

TABLE

| Chemical Process | Operating Temperature Range (K) |
|---|---|
| Molten Salt Hydrofluorination | 1000-1200 |
| Reductive Extraction (salt system) | 773-873 |
| Electrowinning | 773-923 |
| Calcium Reduction | 1050-1123 |
| Electrorefining | 973-1123 |
| Reductive Extraction (metal | 773-873 |
| system) | |

The thermodynamic properties of the species being reduced and the electrochemical kinetics of the system determine the electrochemical reduction potentials required for the electrowinning and electrorefining process.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for processing spent fuel from nuclear reactors, which comprises the steps of:
a. converting the spent fuel to metallic elements;
b. electrorefining uranium and thorium onto an electrode, thereby separating uranium and thorium from the metallic elements;
c. electrorefining transuranic elements into a molten bismuth cathode, forming thereby a first solution and separating the transuranic elements from the metallic elements;
d. exposing the second solution to a flux of fast neutrons for a chosen length of time; and
e. separating the transmutation products for storage thereof; whereby plutonium and higher actinides, and fission products are transmuted to a chosen degree.

2. The method for processing spent fuel from nuclear reactors as described in claim 1, further comprising the step of homogeneously mixing the molten bismuth first solution with molten lead forming thereby a second solution;

3. The method for processing spent fuel from nuclear reactors as described in claim 2, wherein the fast neutrons are generated from the interaction of a high-intensity proton beam with the second solution.

4. The method for processing spent fuel from nuclear reactors as described in claim 1, wherein the second solution is surrounded by thorium, whereby ²³³U is generated.

5. The method for processing spent fuel from nuclear reactors as described in claim 4, wherein the separated uranium is combined with the ²³³U generated from the thorium for producing enriched fuel.
